(19) United States
(12) Patent Application Publication
(10) Pub. No.: US 2018/0070686 A1
(43) Pub. Date: Mar. 15, 2018

(54) RING AND PENDANT DEVELOPED TO KEEP PETS MEMORIES

(71) Applicant: Aline Cristina de Cezaro, Curitiba-Parana (BR)

(72) Inventor: Aline Cristina de Cezaro, Curitiba-Parana (BR)

(21) Appl. No.: 15/701,418

(22) Filed: Sep. 11, 2017

(30) Foreign Application Priority Data
Sep. 11, 2016 (BR) PI 102016026268-2

(51) Int. Cl. A44C 9/00; A61G 17/007; A44C 15/00; A44C 17/02

(52) U.S. Cl. CPC A44C 9/0069; A44C 17/02; A44C 15/001; A61G 17/0076

(57) ABSTRACT

The invention of this patent application concerns that it was developed to keep pets memories of when they were alive, which corresponds to photos, hairs and nails or after death, in this case the ashes from cremation, characterized by comprising a receptacle or base (3) of circular shape or any other geometric shape, on which fits a lid (4) with the shape of the foot or paw of a hollow animal (5) which can be used hanging on a Chain, on a ring, on bracelets, earrings, key chains, anklets, shrines, and/or other objects of personal use.

The referred discription of Patent of Invention relates to Ring and Pendant Developed for Keeping Pet memories, hereinafter referred to as Ring and Pendant, which are intended to hold the memories of pets, when they were alive, with hair, photos and nails or after death, with ashes coming from cremation.

The field of application of this Ring and Pendant, refers to the Pet market, aviaries, veterinary clinics, crematories, jewelers, watchmaking and any interested person.

The main purpose of this Ring and Pendant is to be used for the storage of small pet memories, highlighting among them, hairs, photos and nails, when they were alive, or after death, the ashes from the cremation.

As it is well known, nowadays in order to keep memories of animals, when they were alive, there is nothing specific for the intended purposes, consequently objects of human use end up being adapted in order to keep some memories of these animals, and when they die, amphoras are used to store the ashes of the pets after their cremation, which means that this situation confirms the lack of products specifically made to store the ashes and other memories of beloved pets.

In order to evaluate the prior art, anteriority searches have been carried out at the PTO database and it was found one document, namely Brazilian Patent Application BR 102014027976-8, filed on Nov. 7, 2014, which title is “CRYSTAL CAPSULE FOR PACKAGING MORTUARY ASHES”; Patent invention which belongs to ash guarding products of loved ones comprised of a crystal capsule with a hollow core and provided with at least one opening which allows the deposition of mortuary ashes in the internal region of the referred capsule. The opening of the capsule may be closed through a material other than that of the capsule surface by gluing. The product obtained comprises a capsule, of varying shape and size, which has a hollow core forming a chamber suitable for the packing of the mortuary ashes, with the opening of the capsule being closed by suitable closing means, made by different material from the one which composes the capsule, by gluing.

As it can be noticed from the prior art disclosure, the described document has no similarity with respect to the subject matter of the present invention.

Furthermore, searches of state of the art were performed using the International Classification A61G 17/007 and nothing identical or like the referred invention has been found.

The main difference is intended to provide a small jewel, in this case a ring or pendant, or both, made of any metal having the same configuration, and it is formed by a circular receptacle or any other geometric shape with its upper face, or lid in the shape of a leaked paw, which may be used hanging from a chain, a ring, bracelets, key chains earrings, anklets, reliquaries and other objects for personal use.

In order to obtain full and complete visualization of how the Ring and Pendant in question and the object of this present Invention is constituted, the referred description is accompanied by illustrative drawings, to which references are made as follows:

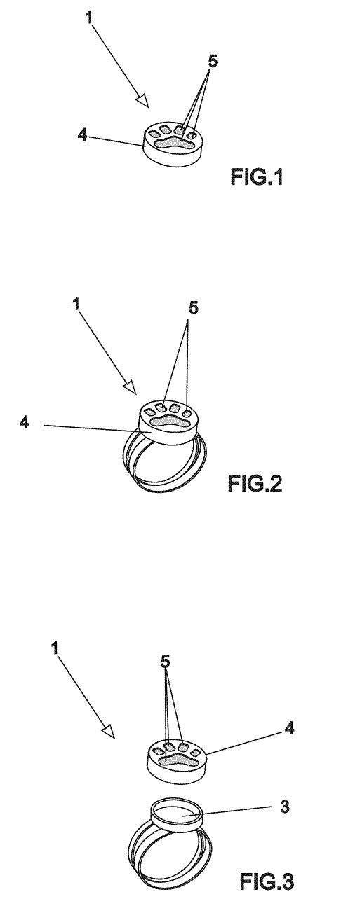

FIG. 1 represents a view in top perspective circular receptacle in the shape of a hollow Paw;

FIG. 2: Corresponds to the perspective view of the assembled ring;

FIG. 3: Shows a view in exploded perspective of the ring, showing the base of which is superimposed the upper receptacle of the same;

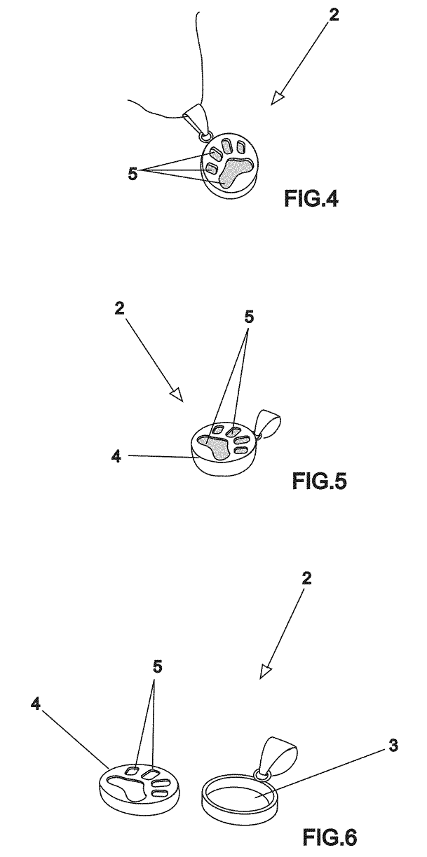

FIG. 4: Shows perspective view a chain with hanging pendant;

FIG. 5: Illustrates the pendant itself;

FIG. 6: Represents the perspective view of the disassembled pendant, showing the base and the pendant lid.

As it can be seen from the accompanying drawings which are an integral part of this description, the Ring (1) and Pendant (2) were developed to store pet memories, referred to when the animals were alive, which corresponds to photos, hair and nails or After death, in this case, ashes from the cremation.

The Ring (1) and the Pendant (2) are characterized by having a receptacle or base (3) of circular shape or of any other geometric shape, onto which a cap (4) (5) which may be worn on a chain, on a ring, on bracelets, earrings, key chains, anklets, shrines, and/or other objects of personal use.

These small ornamental objects allow to keep memories of animals that have passed in our life, being able to honor them in life with hairs, nails and photos and after his death with his ashes coming from the cremation.

It can be verified by everything already has been described and illustrated that this ring and pendant (1) which fits perfectly within the rules governing proper Patent and fills an important gap in the market, even possessing and providing Characteristics and technical provisions, which make it worthy of the requested privilege.

The invention claimed is:

1) “RING AND PENDANT DEVELOPED TO KEEP PETS MEMORIES” which was developed to keep the memories of pets, which, when they were alive, corresponds to photos, hairs and nails or after death, in this case, to ashes of the cremation, wherein it has a receptacle or base (3) of circular shape or any other geometric shape, on which it fits a lid (4) with the shape of a foot or a paw of a cast animal (5) that is fitted and which can be used hanging on a chain, a ring, or any other type of jewelry or jewelry imitation.
